(19) United States
(12) Patent Application Publication
(10) Pub. No.: US 2023/0104505 A1
(43) Pub. Date: Apr. 6, 2023

(54) COMPOSITION WITH PRESSURE-SENSITIVE ADHESIVENESS, PRESSURE-SENSITIVE ADHESIVE, AND PRESSURE-SENSITIVE ADHESIVE SHEET

(71) Applicant: LINTEC CORPORATION, Tokyo (JP)

(72) Inventors: Shuhei KUBO, Tokyo (JP); Takeshi MORI, Tokyo (JP); Takeshi ANSAI, Tokyo (JP)

(73) Assignee: LINTEC CORPORATION, Tokyo (JP)

(21) Appl. No.: 17/801,893

(22) PCT Filed: Dec. 21, 2020
(86) PCT No.: PCT/JP2020/047783

§ 371 Date: Aug. 24, 2022

(30) Foreign Application Priority Data
Feb. 25, 2020 (JP) 2020-029867

(51) Int. Cl. C09J 7/38; C09J 11/04; C09J 133/10

(52) U.S. Cl. CPC C09J 7/385; C09J 11/04; C09J 133/10; C08K 2201/004; C08K 2003/3045

(57) ABSTRACT

A pressure sensitive adhesive composition containing: a (meth)acrylic ester polymer (A) including an alkyl (meth)acrylate monomer (a1) and a reactive functional group-containing monomer (b) as monomer units that constitute the polymer; and an inorganic filler (C), wherein the carbon number of an alkyl group in the alkyl (meth)acrylate monomer (a1) is 6 or more and the alkyl group is linear. In the pressure sensitive adhesive composition, the inorganic filler can be uniformly dispersed in a short time even when a dispersant is not contained.

### TECHNICAL FIELD

The present invention relates to a pressure sensitive adhesive composition and a pressure sensitive adhesive that contain an inorganic filler and also to a pressure sensitive adhesive sheet comprising a pressure sensitive adhesive layer that contains an inorganic filler.

### BACKGROUND ART

Pressure sensitive adhesives can develop various functions such as conductivity, thermal conductivity, insulating properties, mechanical strength, and light diffusivity by adding various fillers. Such pressure sensitive adhesives containing fillers are used in a wide range of technical fields. For example, Patent Document 1 discloses a filler-containing pressure sensitive adhesive tape comprising a pressure sensitive adhesive layer that contains a pressure sensitive adhesive resin including an acrylic polymer and a filler dispersed in the pressure sensitive adhesive resin.

### PRIOR ART DOCUMENTS

### Patent Documents

[Patent Document 1] JP2018-53136A

### SUMMARY OF THE INVENTION

### Problems to be Solved by the Invention

In the conventional filler-containing pressure sensitive adhesive layer as disclosed in Patent Document 1, however, the filler, particularly an inorganic filler, may not be sufficiently dispersed. If the dispersivity of the filler is low, the filler remains cohesive in the pressure sensitive adhesive layer. In such a pressure sensitive adhesive layer, there arise problems in that not only the desired functions cannot be sufficiently exhibited, but also the adhesive strength and the fracture strength are lowered.

In addition, a dispersant may be added to the pressure sensitive adhesive in order to improve the dispersibility of the filler, but the addition of a dispersant may adversely affect the physical properties such as adhesive strength and fracture elongation.

The present invention has been made in view of such circumstances and objects of the present invention include providing a pressure sensitive adhesive composition in which an inorganic filler can be uniformly dispersed in a short time even when a dispersant is not contained, a pressure sensitive adhesive in which an inorganic filler is uniformly dispersed, and a pressure sensitive adhesive sheet comprising a pressure sensitive adhesive layer in which an inorganic filler is uniformly dispersed.

### Means for Solving the Problems

To achieve the above objects, first, the present invention provides a pressure sensitive adhesive composition containing: a (meth)acrylic ester polymer (A) including an alkyl (meth)acrylate monomer (a1) and a reactive functional group-containing monomer (b) as monomer units that constitute the polymer; and an inorganic filler (C), wherein a carbon number of an alkyl group in the alkyl (meth)acrylate monomer (a1) is 6 or more and the alkyl group is linear (Invention 1).

In the above invention (Invention 1), the (meth)acrylic ester polymer (A) includes the alkyl (meth)acrylate monomer (a1), in which the carbon number of the alkyl group is 6 or more and the alkyl group is linear, and a reactive functional group-containing monomer (b) as the monomer units that constitute the polymer, and the cohesion of the inorganic filler (C) is thereby suppressed. This allows the inorganic filler (C) to be uniformly dispersed in a short time even when the pressure sensitive adhesive composition does not contain a dispersant.

In the above invention (Invention 1), the (meth)acrylic ester polymer (A) may preferably include, in addition to the alkyl (meth)acrylate monomer (a1), an alkyl (meth)acrylate monomer (a2) (except for those in which the carbon number of the alkyl group is 6 or more and the alkyl group is linear) as a monomer unit that constitutes the polymer (Invention 2).

In the above invention (Invention 2), the (meth)acrylic ester polymer (A) may preferably contain 30 mass % or more and 95 mass % or less of the alkyl (meth)acrylate monomer (a2) as the monomer unit that constitutes the polymer (Invention 3).

In the above invention (Invention 1 to 3), the (meth)acrylic ester polymer (A) may preferably contain 5 mass % or more and 50 mass % or less of the alkyl (meth)acrylate monomer (a1) as a monomer unit that constitutes the polymer (Invention 4).

In the above invention (Invention 1 to 4), the reactive functional group-containing monomer (b) may be preferably a carboxy group-containing monomer (Invention 5).

In the above invention (Invention 1 to 5), the inorganic filler (C) may preferably comprise barium sulfate (Invention 6).

In the above invention (Invention 1 to 6), an average particle diameter of primary particles of the inorganic filler (C) may be preferably 0.01 μm or more and 10 μm or less (Invention 7).

In the above invention (Invention 1 to 7), the pressure sensitive adhesive composition may preferably contain a crosslinker (B) (Invention 8).

Second, the present invention provides a pressure sensitive adhesive obtained by crosslinking the pressure sensitive adhesive composition (Invention 1 to 8) (Invention 9).

Third, the present invention provides a pressure sensitive adhesive sheet comprising at least a pressure sensitive adhesive layer, wherein the pressure sensitive adhesive layer is formed from the pressure sensitive adhesive composition (Invention 1 to 8) (Invention 10).

In the above invention (Invention 10), the pressure sensitive adhesive sheet may preferably comprise: a base material; and the pressure sensitive adhesive layer provided on one surface side of the base material (Invention 11).

In the above invention (Invention 10, 11), the pressure sensitive adhesive layer may preferably have a thickness of 1 μm or more and 50 μm or less (Invention 12).

### Advantageous Effect of the Invention

According to the pressure sensitive adhesive composition of the present invention, the inorganic filler can be uniformly dispersed in a short time even when a dispersant is not contained. Moreover, the pressure sensitive adhesive and the pressure sensitive adhesive layer of the pressure sensitive adhesive sheet according to the present invention are configured such that the inorganic filler is uniformly dispersed even when a dispersant is not contained.

### BRIEF DESCRIPTION OF DRAWINGS

FIG. 1 is a cross-sectional view of a pressure sensitive adhesive sheet according to an embodiment of the present invention.

FIG. 2 is a graph of particle size distribution measured in Testing Examples 1 and 2.

### EMBODIMENTS FOR CARRYING OUT THE INVENTION

Hereinafter, one or more embodiments of the present invention will be described.

### Pressure Sensitive Adhesive Composition

The pressure sensitive adhesive composition according to the present embodiment (which may be referred to as a “pressure sensitive adhesive composition P,” hereinafter) contains: a (meth)acrylic ester polymer (A) including an alkyl (meth)acrylate monomer (a1) and a reactive functional group-containing monomer (b) as monomer units that constitute the polymer; and an inorganic filler (C). The carbon number of an alkyl group in the above alkyl (meth)acrylate monomer (a1) is 6 or more and the alkyl group is linear. The (meth)acrylic ester polymer (A) includes the above monomers as the constituent monomer units, and the cohesion of the inorganic filler (C) is thereby suppressed. The reason of this is not clear, but it is considered that steric hindrance due to the bulky alkyl (meth)acrylate monomer (a1), the polarity of the reactive functional group-containing monomer, and their behaviors in a solution are related. The cohesion of the inorganic filler (C) is suppressed as above, and the inorganic filler (C) can thereby be uniformly dispersed in a short time even when the pressure sensitive adhesive composition P does not contain a dispersant.

As used in the present specification, the term “(meth)acrylic ester” refers to both the acrylic ester and the methacrylic ester. The same applies to other similar terms. As used in the present specification, the term “polymer” encompasses the concept of a “copolymer.”

### 1. Each Component

### (1) (Meth)acrylic Ester Polymer (A)

The (meth)acrylic ester polymer (A) includes the alkyl (meth)acrylate monomer (a1) and the reactive functional group-containing monomer (b) as the monomer units which constitute the polymer.

The alkyl group in the alkyl (meth)acrylate monomer (a1) is linear, and the carbon number of the alkyl group is 6 or more. The upper limit of the carbon number of the alkyl group may be preferably 22 or less. This allows the obtained pressure sensitive adhesive to have satisfactory pressure sensitive adhesive properties.

Examples of the alkyl (meth)acrylate monomer (a1) include n-hexyl (meth)acrylate (C6), n-heptyl (meth)acrylate (C7), n-octyl (meth)acrylate (C8), n-nonyl (meth)acrylate (C9), n-decyl (meth)acrylate (C10), dodecyl (meth)acrylate (C12: lauryl (meth)acrylate), tetradecyl (meth)acrylate (C14: myristyl (meth)acrylate), hexadecyl (meth)acrylate (C16: palmityl (meth)acrylate), octadecyl (meth)acrylate (C18: stearyl (meth)acrylate), n-icosyl (meth)acrylate (C20), and n-docosyl (meth)acrylate (C22). Among these, those having an alkyl group whose carbon number is 6 to 18 may be preferred, n-hexyl (meth)acrylate, n-decyl (meth)acrylate, dodecyl (meth)acrylate, or octadecyl (meth)acrylate may be particularly preferred, and n-hexyl (meth)acrylate, n-decyl methacrylate, dodecyl (meth)acrylate, or octadecyl (meth)acrylate may be further preferred. One type of the alkyl (meth)acrylate monomer (a1) can be used alone or two or more types can also be used in combination.

The (meth)acrylic ester polymer (A) may preferably contain 5 mass % or more, more preferably 7 mass % or more, particularly preferably 10 mass % or more, and further preferably 15 mass % or more of the alkyl (meth)acrylate monomer (a1) as the monomer unit which constitutes the polymer. From another aspect, the (meth)acrylic ester polymer (A) may preferably contain 50 mass % or less, more preferably 45 mass % or less, particularly preferably 40 mass % or less, and further preferably 35 mass % or less of the alkyl (meth)acrylate monomer (a1) as the monomer unit which constitutes the polymer. When the (meth)acrylic ester polymer (A) contains the alkyl (meth)acrylate monomer (a1) in the above amount as the monomer unit which constitutes the polymer, the dispersibility of the inorganic filler (C) is more excellent.

Preferred examples of the reactive functional group-containing monomer (b) include a monomer having a carboxy group in the molecule (carboxy group-containing monomer), a monomer having a hydroxyl group in the molecule (hydroxyl group-containing monomer), and a monomer having an amino group in the molecule (amino group-containing monomer). Among these, the carboxy group-containing monomer and the hydroxyl group-containing monomer may be preferred and the carboxy group-containing monomer may be particularly preferred from the viewpoint of exhibiting excellent dispersibility. These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. Among these, the acrylic acid may be preferred from the viewpoint of exhibiting more excellent dispersibility. These may each be used alone or two or more types may also be used in combination.

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. These may each be used alone or two or more types may also be used in combination.

Examples of the amino group-containing monomer include aminoethyl (meth)acrylate and n-butylaminoethyl (meth)acrylate. These may each be used alone or two or more types may also be used in combination.

The (meth)acrylic ester polymer (A) may preferably contain 0.5 mass % or more, particularly preferably 1 mass % or more, and further preferably 3 mass % or more of the reactive functional group-containing monomer (b) as the monomer unit which constitutes the polymer. From another aspect, the (meth)acrylic ester polymer (A) may preferably contain 30 mass % or less, particularly preferably 20 mass % or less, and further preferably 10 mass % or less of the reactive functional group-containing monomer (b) as the monomer unit which constitutes the polymer. When the (meth)acrylic ester polymer (A) contains the reactive functional group-containing monomer (b) in the above amount as the monomer unit, the dispersibility of the inorganic filler (C) is more excellent.

The (meth)acrylic ester polymer (A) in the present embodiment may preferably include, in addition to the above alkyl (meth)acrylate monomer (a1), an alkyl (meth)acrylate monomer (a2) (except for those in which the carbon number of the alkyl group is 6 or more and the alkyl group is linear) as a monomer unit that constitutes the polymer. This allows the obtained pressure sensitive adhesive to develop satisfactory pressure sensitive adhesive properties. The alkyl group may be linear (when the carbon number is 5 or less) or branched or may have a cyclic structure.

Specifically, the alkyl (meth)acrylate monomer (a2) may be an alkyl (meth)acrylate in which the carbon number of the alkyl group is 1 to 5 or an alkyl (meth)acrylate in which the carbon number of the alkyl group is 6 or more and the alkyl group is not linear. Examples of the alkyl (meth)acrylate in which the carbon number of alkyl group is 1 to 5 include methyl (meth)acrylate, ethyl (meth)acrylate, propyl (meth)acrylate, n-butyl (meth)acrylate, and n-pentyl (meth) acrylate.

The carbon number of the alkyl group in the alkyl (meth)acrylate in which the carbon number of the alkyl group is 6 or more and the alkyl group is not linear may be preferably 6 or more, particularly preferably 7 or more, and further preferably 8 or more. From another aspect, the carbon number of the alkyl group may be preferably 20 or less, more preferably 12 or less, particularly preferably 10 or less, and further preferably 8 or less. On the other hand, the above alkyl group may be preferably branched.

Examples of the alkyl (meth)acrylate in which the carbon number of the alkyl group is 6 or more and the alkyl group is not linear include isohexyl (meth)acrylate, 2-ethylhexyl (meth) acrylate, isooctyl (meth) acrylate, isononyl (meth)acrylate, isodecyl (meth)acrylate, iaostearyl (meth) acrylate, cyclohexyl (meth) acrylate, isobornyl (meth)acrylate, and adamantyl (meth)acrylate. Among the above, 2-ethylhexyl (meth)acrylate may be preferred, which has high pressure sensitive adhesive properties and does not inhibit excellent dispersibility in combination with the alkyl (meth)acrylate monomer (a1) and the reactive functional group-containing monomer (b), and 2-ethylhexyl acrylate may be particularly preferred. These may each be used alone or two or more types may also be used in combination.

The (meth)acrylic ester polymer (A) may preferably contain 30 mass % or more, more preferably 40 mass % or more, particularly preferably 50 mass % or more, and further preferably 60 mass % or more of the alkyl (meth)acrylate monomer (a2) as the monomer unit which constitutes the polymer. When the content of the alkyl (meth)acrylate monomer (a2) is as above, the (meth)acrylic ester polymer (A) can exhibit suitable pressure sensitive adhesive properties. From another aspect, the (meth)acrylic ester polymer (A) may preferably contain 95 mass % or less, more preferably 90 mass % or less, and particularly preferably 85 mass % or less of the alkyl (meth)acrylate monomer (a2) as the monomer unit which constitutes the polymer. When the content of the alkyl (meth)acrylate monomer (a2) is as above, an appropriate amount of other monomer components can be introduced into the (meth)acrylic ester polymer (A).

The (meth)acrylic ester polymer (A) may contain one or more other monomers, if desired, as the monomer units which constitute the polymer.

Examples of the above other monomers include alkoxyalkyl (meth)acrylates such as methoxyethyl (meth)acrylate and ethoxyethyl (meth)acrylate, (meth)acrylic ester having a non-crosslinkable tertiary amino group, such as N,N-dimethylaminoethyl (meth)acrylate, N,N-dimethylaminopropyl (meth) acrylate, and (meth) acryloylmorpholin, (meth) acrylamide, dimethylacrylamide, vinyl acetate, and styrene. These may each be used alone or two or more types may also be used in combination.

The (meth)acrylic ester polymer (A) may be solution-polymerized, polymerized without solvent, or emulsion-polymerized. Among the above, a solution polymerization product obtained by a solution polymerization method may be preferred. By being a solution polymerization product, it is easy to suppress the cohesion of the inorganic filler (C) and make the dispersibility excellent.

The polymerization form of the (meth)acrylic ester polymer (A) may be a random copolymer or may also be a block copolymer.

The weight-average molecular weight of the (meth)acrylic ester polymer (A) may be preferably 50,000 or more, particularly preferably 250,000 or more, and further preferably 500,000 or more as the lower limit. From another aspect, the weight-average molecular weight of the (meth)acrylic ester polymer (A) may be preferably 2,500,000 or less, particularly preferably 2,000,000 or less, and further preferably 1,500,000 or less as the upper limit. When the weight-average molecular weight of the (meth)acrylic ester polymer (A) is within the above range, the dispersibility of the inorganic filler (C) is more excellent. As used in the present specification, the weight-average molecular weight refers to a standard polystyrene equivalent value that is measured by using a gel permeation chromatography (GPC) method.

In the pressure sensitive adhesive composition P, one type of the (meth)acrylic ester polymer (A) may be used alone or two or more types may also be used in combination.

### (2) Crosslinker (B)

It suffices that the crosslinker (B) is reactive with a reactive functional group of the (meth)acrylic ester polymer (A). Examples of the crosslinker (B) include an isocyanate-based crosslinker, an epoxy-based crosslinker, an amine-based crosslinker, a melamine-based crosslinker, an aziridine-based crosslinker, a hydrazine-based crosslinker, an aldehyde-based crosslinker, an oxazoline-based crosslinker, a metal alkoxide-based crosslinker, a metal chelate-based crosslinker, a metal salt-based crosslinker, and an ammonium salt-based crosslinker. One type of the crosslinker (B) may be used alone or two or more types may also be used in combination.

When the reactive functional group of the (meth)acrylic ester polymer (A) is a carboxy group, it may be preferred to use, among the above, the isocyanate-based crosslinker from the viewpoint of the reactivity with the carboxy group.

The isocyanate-based crosslinker contains at least a polyisocyanate compound. Examples of the polyisocyanate compound include aromatic polyisocyanates such as tolylene diisocyanate, diphenylmethane diisocyanate and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among the above, trimethylolpropane-modified aromatic polyisocyanate may be preferred, and trimethylolpropane-modified tolylene diisocyanate and trimethylolpropane-modified xylylene diisocyanate may be particularly preferred.

The content of the crosslinker (B) in the pressure sensitive adhesive composition P may be preferably 0.1 mass parts or more, particularly preferably 0.5 mass parts or more, and further preferably 1 mass part or more as the lower limit with respect to 100 mass parts of the (meth)acrylic ester polymer (A). From another aspect, the content may be preferably 20 mass parts or less, particularly preferably 15 mass parts or less, and further preferably 10 mass parts or less as the upper limit. When the content of the crosslinker (B) is within the above range, the crosslinked structure is satisfactorily formed, and the cohesive strength of the obtained pressure sensitive adhesive is moderately high.

### (3) Inorganic Filler (C)

The inorganic filler (C) may be selected such that the obtained pressure sensitive adhesive layer exhibits desired functions. Examples of the inorganic filler (C) include powders of calcium carbonate, aluminum hydroxide, alumina, titania, silica, boehmite, talc, iron oxide, silicon carbide, barium sulfate, boron nitride, zirconium oxide, etc., spherical beads thereof, single crystal fibers, and glass fibers. These may each be used alone or two or more types may be mixed and used. Among these, alumina, silica, or barium sulfate may be preferred, and barium sulfate may be particularly preferred. In general, these examples of the inorganic filler (C) may have poor dispersibility, but they exhibit excellent dispersibility in the pressure sensitive adhesive composition P according to the present embodiment.

Examples of the shape of the inorganic filler (C) include granular shape, needle shape, plate shape, scale shape, and indefinite shape, and examples of the granular shape include round shape, true spherical shape, and polygonal shape. When the shape of the inorganic filler (C) is granular shape among the above, the dispersibility may be generally poor, but in the pressure sensitive adhesive composition P according to the present embodiment, excellent dispersibility is exhibited.

The inorganic filler (C) in the present embodiment may be subjected to a desired surface treatment or may not be subjected to a surface treatment. In the case of an inorganic filler that is not subjected to a surface treatment, the dispersibility is generally poor, but in the pressure sensitive adhesive composition P according to the present embodiment, excellent dispersibility is exhibited.

The average particle diameter of primary particles of the inorganic filler (C) may be preferably 0.01 μm or more, more preferably 0.1 μm or more, particularly preferably 0.2 μm or more, and further preferably 0.3 μm or more. From another aspect, the average particle diameter of primary particles of the inorganic filler (C) may be preferably 10 μm or less, particularly preferably 5 μm or less, and further preferably 1 μm or less. When the average particle diameter of primary particles of the inorganic filler (C) is within the above range, the dispersibility of the inorganic filler (C) is more excellent. The average particle diameter of the inorganic filler (C) is measured by a laser diffraction/scattering method.

The content of the inorganic filler (C) in the pressure sensitive adhesive composition P may be preferably 5 mass parts or more, more preferably 10 mass parts or more, particularly preferable 30 mass parts or more, further preferably 50 mass parts or more, and most preferably 60 mass parts or more with respect to 100 mass parts of the (meth)acrylic ester polymer (A). This allows the inorganic filler (C) to sufficiently exhibit the desired functions. From another aspect, the content may be preferably 500 mass parts or less, more preferably 250 mass parts or less, particularly preferably 100 mass parts or less, and further preferably 80 mass parts or less. This allows the adhesive strength of the obtained pressure sensitive adhesive layer to be maintained satisfactorily.

### (4) Various Additives

If desired, the pressure sensitive adhesive composition P can contain various additives usually used for acrylic-based pressure sensitive adhesives, such as a tackifier, an antioxidant, and a softener. The pressure sensitive adhesive composition P can contain a dispersant, but it is not necessary to contain a dispersant because excellent filler dispersibility can be obtained even when a dispersant is not contained. The additives which constitute the pressure sensitive adhesive composition P are deemed not to include a polymerization solvent or a diluent solvent, which will be described later.

### 2. Production of Pressure Sensitive Adhesive Composition

The pressure sensitive adhesive composition P can be produced through producing the (meth)acrylic ester polymer (A) and mixing the obtained (meth)acrylic ester polymer (A) and the inorganic filler (C) and, if desired, the crosslinker (B) and additives. The crosslinker (B) may be added before or after the dispersion treatment, which will be described later. In the present embodiment, even when the pressure sensitive adhesive composition P does not contain the crosslinker (B), the inorganic filler (C) exhibits excellent dispersibility.

The (meth)acrylic ester polymer (A) can be produced by polymerizing a mixture of the monomers which constitute the polymer using a commonly-used radical polymerization method. Polymerization of the (meth)acrylic ester polymer (A) may be preferably carried out by a solution polymerization method, if desired, using a polymerization initiator. However, the present invention is not limited to this, and polymerization may be carried out without a solvent. Examples of the polymerization solvent include ethyl acetate, n-butyl acetate, isobutyl acetate, toluene, acetone, hexane, and methyl ethyl ketone and two or more types thereof may also be used in combination.

Examples of the polymerization initiator include azo-based compounds and organic peroxides and two or more types thereof may also be used in combination. Examples of the azo-based compounds include 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane].

Examples of the organic peroxides include benzoyl peroxide, t-butyl perbenzoate, cumene hydroperoxide, diisopropyl peroxydicarbonate, di-n-propyl peroxydicarbonate, di(2-ethoxyethyl)peroxydicarbonate, t-butyl peroxyneodecanoate, t-butyl peroxybivalate, (3,5,5-trimethylhexanoyl)peroxide, dipropionyl peroxide, and diacetyl peroxide.

In the above polymerization step, the weight-average molecular weight of the polymer to be obtained can be adjusted by compounding a chain transfer agent such as 2-mercaptoethanol.

After the (meth)acrylic ester polymer (A) is obtained, the pressure sensitive adhesive composition P may be obtained through adding the inorganic filler (C) and, if desired, the crosslinker (B), additives, etc. to the solution of the (meth)acrylic ester polymer (A) and sufficiently mixing them.

The pressure sensitive adhesive composition P may be appropriately diluted with a diluting solvent or the like in addition to the previously described polymerization solvent to obtain a coating liquid in order to adjust the viscosity to be suitable for the dispersion treatment and coating and to adjust the pressure sensitive adhesive layer to a desired film thickness. Examples of the diluting solvent include ethyl acetate, n-butyl acetate, isobutyl acetate, toluene, acetone, hexane, and methyl ethyl ketone and two or more types may also be used in combination.

The concentration/viscosity of the coating liquid is not particularly limited and can be appropriately selected depending on the situation, provided that the concentration/viscosity is within any range in which the dispersion treatment and coating are possible. For example, the pressure sensitive adhesive composition P may be diluted to a concentration of 10 to 60 mass %. When obtaining the coating liquid, the addition of a diluting solvent or the like is not a necessary condition, and the diluting solvent may not be added if the pressure sensitive adhesive composition P has a viscosity or the like that enables the dispersion treatment and coating. In this case, the pressure sensitive adhesive composition P may be a coating liquid in which the polymerization solvent itself for the (meth)acrylic ester polymer (A) is used as a diluting solvent.

### 3. Dispersion Treatment for Pressure Sensitive Adhesive Composition

The pressure sensitive adhesive composition P (a coating liquid of the pressure sensitive adhesive composition P) may be subjected to a dispersion treatment for dispersing the inorganic filler (C), thereby to be a coating liquid in which the inorganic filler (C) is uniformly dispersed in a short time without cohesion. The dispersion treatment can be performed using a conventionally known disperser. Examples of such a disperser include a rotor/stator type disperser, a jet mill, and a bead mill. Among these, a rotor/stator type disperser or a jet mill, which is a medialess disperser, may be preferred with consideration for prevention of contamination caused by beads for dispersion.

The dispersion treatment time may be preferably 50 minutes or less and more preferably 40 minutes or less. Even when the dispersion treatment time is a short time as above, the pressure sensitive adhesive composition P becomes a coating liquid in which the inorganic filler (C) is uniformly dispersed. That is, according to the pressure sensitive adhesive composition P, a pressure sensitive adhesive sheet having a homogeneous pressure sensitive adhesive layer can be produced with a high production efficiency.

When a rheology index (RI) of the pressure sensitive adhesive composition P (a coating liquid of the pressure sensitive adhesive composition P) is defined as a value calculated with an equation of RI=η₁₀/η₁ from the value of a shear viscosity (η₁₀, unit: mPa·s) at a shear rate of 10 s⁻¹ and the value of a shear viscosity (η₁, unit: mPa·s) at a shear rate of 1 s⁻¹ at the time point after performing the dispersion treatment for 40 minutes (a rotor/stator type disperser is used in the testing example), the value of RI may be preferably 0.85 or more, particularly preferably 0.86 or more, and further preferably 0.87 or more. In general, when the state is close to a completely dispersed state, the shear viscosity does not vary from a low shear region to a high shear region, and it can therefore be said that the inorganic filler (C) is sufficiently and uniformly dispersed with the RI being as above.

### Pressure Sensitive Adhesive

The pressure sensitive adhesive according to the present embodiment is obtained by crosslinking the previously described pressure sensitive adhesive composition P. Crosslinking of the pressure sensitive adhesive composition P can usually be carried out by heat treatment. Drying treatment when volatilizing a diluent solvent and the like from the coating film of the pressure sensitive adhesive composition P applied to a desired object can also serve as the above heat treatment.

The heating temperature of the heat treatment may be preferably 50° C. to 150° C. and particularly preferably 70° C. to 120° C. The heating time may be preferably 30 seconds to 10 minutes and particularly preferably 50 seconds to 5 minutes.

After the heat treatment, if necessary, an aging period at an ordinary temperature (e.g., 23° C., 50% RH) for about 1 to 2 weeks may be provided. When the aging period is necessary, the pressure sensitive adhesive layer is formed after the aging period passes, while when the aging period is not necessary, the pressure sensitive adhesive layer is formed after the heat treatment.

### Pressure Sensitive Adhesive Sheet

The pressure sensitive adhesive sheet according to the present embodiment is a pressure sensitive adhesive sheet comprising at least a pressure sensitive adhesive layer formed from the previously described pressure sensitive adhesive composition P (a pressure sensitive adhesive layer comprising the previously described pressure sensitive adhesive). The pressure sensitive adhesive sheet according to the present embodiment may be obtained by laminating a base material on one surface side of the pressure sensitive adhesive layer and laminating a release sheet on the other surface or may also be obtained by laminating release sheets on both surfaces of the pressure sensitive adhesive layer.

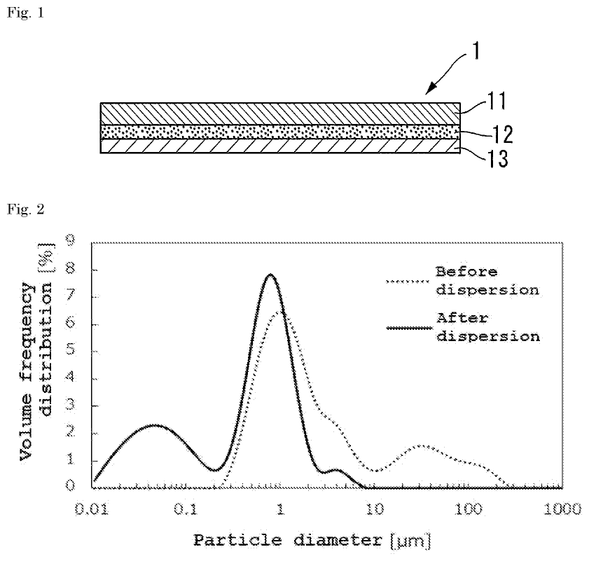

FIG. 1 illustrates a specific configuration as an example of the pressure sensitive adhesive sheet according to the present embodiment.

As illustrated in FIG. 1, the pressure sensitive adhesive sheet 1 according to the present embodiment may be configured to comprise a base material 11, a pressure sensitive adhesive layer 12 laminated on one surface side of the base material 11, and a release sheet 13 laminated on the surface of the pressure sensitive adhesive layer 12 opposite to the base material 11. The release sheet 13 may be laminated so that its release surface is in contact with the pressure sensitive adhesive layer 12. The release surface of a release sheet in the present specification refers to a surface having releasability in the release sheet, and examples of the release surface include both a surface subjected to release treatment and a surface that exhibits releasability even without being subjected to release treatment.

### 1. Each Element

### (1) Base Material

The base material 11 in the present embodiment can be appropriately set in accordance with the use of the pressure sensitive adhesive sheet 1 and may be preferably a resin film in which the main material is a resin-based material. Specific examples of the base material 11 include polyolefin-based films, such as polyethylene films, polypropylene films, polybutene films, polybutadiene films, polymethylpentene films, ethylene-norbornene copolymer films, and norbornene resin films; polyester-based films, such as polyethylene terephthalate films, polybutylene terephthalate films, and polyethylene naphthalate films; ethylene-vinyl acetate copolymer films; ethylene-based copolymer films, such as ethylene-(meth)acrylic acid copolymer films, ethylene-(meth)acrylic acid methyl copolymer films, and other ethylene-(meth)acrylic ester copolymer films; polyvinylchloride-based films, such as polyvinyl chloride films and vinyl chloride copolymer films; (meth)acrylic ester copolymer films; polyurethane films; polyimide films; polystyrene films; polycarbonate films; and fluorine resin films. Modified films such as crosslinked films and ionomer films thereof may also be used. The base material 11 may be a laminated film obtained by laminating a plurality of the above-described films. In such a laminated film, materials that constitute each layer may be the same type or may also be different types.

The base material 11 may contain various additives, such as a flame retardant, a plasticizer, an antistatic, a glidant, an antioxidant, a colorant, an infrared absorber, an ultraviolet absorber, and an ion scavenger. The content of these additives is not particularly limited and may be preferably within a range in which the base material 11 exhibits desired functions.

To enhance the interfacial adhesion with the pressure sensitive adhesive layer 12, surface treatment such as primer treatment, corona treatment, or plasma treatment may be performed for the surface of the base material 11 on which or above which the pressure sensitive adhesive layer 12 is laminated. On the other hand, the base material 11 may be a release sheet, and in this case, the surface on which the pressure sensitive adhesive layer 12 is laminated may be subjected to release treatment.

The thickness of the base material 11 can be appropriately set in accordance with the use of the pressure sensitive adhesive sheet 1. In general, the thickness may be preferably 5 μm or more, particularly preferably 10 μm or more, and further preferably 15 μm or more. From another aspect, the thickness may be preferably 200 μm or less, particularly preferably 100 μm or less, and further preferably 70 μm or less.

### (2) Pressure Sensitive Adhesive Layer

The pressure sensitive adhesive layer 12 is a pressure sensitive adhesive layer formed from the previously described pressure sensitive adhesive composition P (a pressure sensitive adhesive layer comprising the previously described pressure sensitive adhesive), and in the pressure sensitive adhesive layer, the inorganic filler (C) is uniformly dispersed. In the pressure sensitive adhesive layer 12, no cohesion of the inorganic filler (C) is observed on the coating surface or the cross section.

The thickness of the pressure sensitive adhesive layer 12 (a value measured in accordance with JIS K7130) can be appropriately set in accordance with the use of the pressure sensitive adhesive sheet 1. In general, the thickness of the pressure sensitive adhesive layer 12 may be preferably 1 μm or more, particularly preferably 3 μm or more, and further preferably 5 μm or more. This allows the desired functions and desired adhesive strength to be exhibited due to the inorganic filler (C). From another aspect, the thickness of the pressure sensitive adhesive layer 12 may be preferably 50 μm or less, particularly preferably 13 μm or less, and further preferably 9 μm or less.

On the other hand, the thickness of the pressure sensitive adhesive layer 12 may be preferably 1.1 times or more, more preferably 5 times or more, particularly preferably 10 times or more, and further preferably 15 times or more the average particle diameter of the inorganic filler (C). This allows the surface of the pressure sensitive adhesive layer 12 to have excellent smoothness, and high adhesive strength can be effectively obtained. The upper limit of the magnification of the thickness of the pressure sensitive adhesive layer 12 with reference to the average particle diameter of the inorganic filler (C) is not particularly limited, but may be preferably 100 times or less, more preferably 60 times or less, and particularly preferably 30 times or less.

### (3) Release Sheet

The release sheet 13 is to protect the pressure sensitive adhesive layer 12 until the use of the pressure sensitive adhesive sheet 1 and is removed when using the pressure sensitive adhesive sheet 1. In the pressure sensitive adhesive sheet 1 according to the present embodiment, the release sheet 13 may not necessarily be required.

Examples of the release sheet 13 for use include a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene vinyl acetate film, an ionomer resin film, an ethylene-(meth)acrylic acid copolymer film, an ethylene-(meth)acrylic ester copolymer film, a polystyrene film, a polycarbonate film, a polyimide film, a fluorine resin film and a liquid crystal polymer film. A crosslinked film thereof may also be used. A laminated film thereof may also be used.

It may be preferred to perform release treatment for the release surface (surface to be in contact with the pressure sensitive adhesive layer 12) of the release sheet 13. Examples of a release agent to be used for the release treatment include alkyd-based, silicone-based, fluorine-based, unsaturated polyester-based, polyolefin-based, and wax-based release agents.

The thickness of the release sheet 13 is not particularly limited, but may be usually about 20 to 150 μm.

### 2. Method of Producing Pressure Sensitive Adhesive Sheet

The method of producing the pressure sensitive adhesive sheet 1 according to the present embodiment is not particularly limited, provided that the pressure sensitive adhesive layer 12 can be formed on one side of the base material 11. For example, the release surface of the release sheet 13 is coated with a coating liquid that contains the previously described pressure sensitive adhesive composition P and, if desired, a solvent, and heat treatment is performed to form a coating layer. Then, one surface of the base material 11 is attached to the surface of the coating layer opposite to the release sheet 13. When an aging period is necessary, the above coating layer may become the pressure sensitive adhesive layer 11 after the aging period passes, while when an aging period is not necessary, the above coating layer formed as such may be the pressure sensitive adhesive layer 11. This allows the above pressure sensitive adhesive sheet 1 to be obtained. Conditions for the heat treatment and aging are as previously described.

Another method of producing the pressure sensitive adhesive sheet 1 according to the present embodiment may include coating one surface of the base material 11 with a coating liquid that contains the pressure sensitive adhesive composition P and, if desired, a solvent, then forming the pressure sensitive adhesive layer 12, and laminating the release sheet 13 on the pressure sensitive adhesive layer 12, if desired, thereby to obtain the pressure sensitive adhesive sheet 1. In this case, the coating with the pressure sensitive adhesive composition P, the heat treatment, and the aging can be carried out in the same manner as in the previously described method.

### 3. Use of Pressure Sensitive Adhesive Sheet

The use of the pressure sensitive adhesive sheet 1 according to the present embodiment is not particularly limited and can be appropriately selected depending on the functions developed by the inorganic filler (C). Examples of the functions developed by the inorganic filler (C) include conductivity, thermal conductivity, insulating properties, mechanical strength, and light diffusivity. When the inorganic filler (C) comprises alumina, silica, or barium sulfate, excellent insulating properties are developed.

Examples of the parts to which the pressure sensitive adhesive sheet 1 according to the present embodiment is applied include electronic parts, semiconductor parts, optical parts, and mechanical parts. Examples of the electronic parts include boards such as flexible boards, rigid boards, and rigid flexible boards, batteries such as lithium ion batteries and nickel-hydrogen batteries, and motors.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

For example, in the pressure sensitive adhesive sheet 1, the release sheet 13 may be omitted. Additionally or alternatively, in the pressure sensitive adhesive sheet 1, one or more layers may be provided between the base material 11 and the pressure sensitive adhesive layer 12.

### EXAMPLES

Hereinafter, the present invention will be described further specifically with reference to examples, etc., but the scope of the present invention is not limited to these examples, etc.

### Example 1

### 1. Preparation of (Meth)acrylic Ester Polymer (A)

The (meth)acrylic ester polymer (A) was prepared by using a solution polymerization method to copolymerize 80 mass parts of 2-ethylhexyl acrylate, 15 mass parts of dodecyl methacrylate (a1-4), and 5 mass parts of acrylic acid. The molecular weight of the (meth)acrylic ester polymer (A) was measured by the method, which will be described later. The weight-average molecular weight (Mw) was 750,000.

### 2. Preparation of Pressure Sensitive Adhesive Composition

A pre-dispersion solution of the pressure sensitive adhesive composition having a solid content concentration of 37.2 mass % was obtained through mixing and sufficiently stirring 100 mass parts (solid content equivalent, here and hereinafter) of the (meth)acrylic ester polymer (A) obtained above, 3.75 mass parts of trimethylol propane-modified tolylene diisocyanate (available from TOYOCHEM CO., LTD., product name “BHS-8515”) as the crosslinker (B), and 72 mass parts of barium sulfate particles (available from Sakai Chemical Industry Co., Ltd., product name “BARIACE B-55,” average particle diameter of primary particles: 0.6 μm) as the inorganic filler (C) and diluting the mixture with methyl ethyl ketone.

Here, Table 1 lists each formulation (solid content equivalent) of the pressure sensitive adhesive composition when the (meth)acrylic ester polymer (A) is 100 mass parts (solid content equivalent). Details of the simplified names listed in Table 1 and additional information are as follows.

### «(Meth)acrylic Ester Polymer (A)»

2EHA: 2-ethylhexyl acrylate

AA: acrylic acid

a1-1: n-hexyl methacrylate (carbon number of alkyl group is 6)

a1-2: n-hexyl acrylate (carbon number of alkyl group is 6)

a1-3: n-decyl methacrylate (carbon number of alkyl group is 10)

a1-4: dodecyl methacrylate (carbon number of alkyl group is 12)

a1-5: dodecyl acrylate (carbon number of alkyl group is 12)

a1-6: octadecyl methacrylate (carbon number of alkyl group is 18)

a1-7: octadecyl acrylate (carbon number of alkyl group is 18)

### «Inorganic Filler (C)»

C1: barium sulfate particles having an average diameter of primary particles of 0.6 μm, unmodified surface (available from Sakai Chemical Industry Co., Ltd., product name “BARIACE B-55”)

C2: silica particles having an average diameter of primary particles of 0.6 μm, unmodified surface (available from Denka Company Limited, product name “SFP-30M”)

C3: alumina particles having an average diameter of primary particles of 0.7 μm, unmodified surface (available from Sumitomo Chemical Company, Limited, product name “AKP-3000”)

### Examples 2 to 16 and Comparative Examples 1 and 2

The pre-dispersion solutions of the pressure sensitive adhesive composition P were prepared in the same manner as in Example 1 except that the composition and weight-average molecular weight (Mw) of the (meth)acrylic ester polymer (A) and the type of the inorganic filler (C) were as listed in Table 1.

Here, the previously described weight-average molecular weight (Mw) refers to a weight-average molecular weight that is measured as a polystyrene equivalent value under the following condition using gel permeation chromatography (GPC) (GPC measurement).

### «Measurement Condition»

Measurement device: HLC-8320 available from Tosoh Corporation
GPC columns (passing through in the following order): available from Tosoh Corporation

| | | | |
|---|---|---|---|
| TSK | gel | super | H-H |
| TSK | gel | super | HM-H |
| TSK | gel | super | H2000 |

Solvent for measurement: tetrahydrofuran
Measurement temperature: 40° C.

### <Testing Example 1> (Measurement of Particle Size Distribution)

The particle size distribution of the inorganic filler (C) in the pre-dispersion solution of the pressure sensitive adhesive composition prepared in each of Examples and Comparative Examples was measured using a particle size analyzer (available from Malvern Panalytical Ltd., product name “Mastersizer 3000”). Table 1 lists the content rate (vol %) of the inorganic filler having a particle diameter of 10 μm or more.

For reference, FIG. 2 illustrates a graph (dotted line) of the particle size distribution of the inorganic filler (C) in the pre-dispersion solution of the pressure sensitive adhesive composition prepared in Example 1.

### <Testing Example 2> (Evaluation of Dispersibility)

For 400 mL of the pre-dispersion solution of the pressure sensitive adhesive composition prepared in each of Examples and Comparative Examples, the dispersion treatment was performed using a rotor/stator type disperser (available from PRIMIX Corporation, product name “Neomixer”) to obtain the dispersion solution of the pressure sensitive adhesive composition. The dispersion treatment was performed while maintaining the solution temperature at 20° C. using a temperature control facility, and the rotation speed of the disperser was set to 10,000 rpm.

The particle size distribution in the dispersion solution of the pressure sensitive adhesive composition obtained by collecting a sample every 10 minutes from the start of the dispersion treatment was measured using a particle size analyzer (available from Malvern Panalytical Ltd., product name “Mastersizer 3000”). Then, the dispersion treatment time (minutes) until coarse particles having a particle diameter (secondary particles) of 10 μm or more were not detected was measured, and the dispersibility was evaluated in accordance with the following evaluation criteria. The results are listed in Table 2. A determination was made that the pressure sensitive adhesive composition of Comparative Example 2 was not able to be dispersed because coarse particles having a particle diameter of 10 μm or more continued to be detected even after the dispersion treatment for 90 minutes.

o: Coarse particles were no longer observed within 40 minutes from the start of the dispersion treatment.

x: Coarse particles were observed even 40 minutes after the start of the dispersion treatment.

For reference, FIG. 2 illustrates a graph (solid line) of the particle size distribution 40 minutes after the start of the dispersion treatment in the dispersion solution of the pressure sensitive adhesive composition prepared in Example 1.

### <Testing Example 3> (Evaluation of Dispersibility by Rheology)

The pre-dispersion solution of the pressure sensitive adhesive composition prepared in each of Examples and Comparative Examples was dispersion-treated for 40 minutes in the same manner as in Testing Example 2. For the obtained dispersion solution, steady flow measurement was performed using a rheometer (available from Anton Paar, product name “MCR302”) to measure the shear viscosity. Then, from the value of a shear viscosity (η₁₀, unit: mPa·s) at a shear rate of 10 s⁻¹ and the value of a shear viscosity (η₁, unit: mPa·s) at a shear rate of 1 s⁻¹, the value of a rheology index (RI)=η₁₀/η₁ was calculated. From the calculated value of RI, the dispersibility was evaluated by rheology based on the following criteria. The results are listed in Table 2.

o: RI value was 0.85 or more

x: RI value was less than 0.85

### <Testing Example 4> (Evaluation of Cohesion)

The pre-dispersion solution of the pressure sensitive adhesive composition prepared in each of Examples and Comparative Examples was dispersion-treated for 40 minutes in the same manner as in Testing Example 2. One surface of a polyethylene terephthalate film (available from Toray Industries, Inc., product name “Lumirror T-60,” thickness: 50 μm) was coated with the obtained dispersion solution by using a knife coater. Then, the coating layer was heated and dried at 100° C. for 2 minutes to form a pressure sensitive adhesive layer having a thickness of 8 μm to obtain a pressure sensitive adhesive sheet. The surface (size: 5 mm×5 mm) of the pressure sensitive adhesive layer of the obtained pressure sensitive adhesive sheet was visually observed as to whether there was a cohesive defect, and the cohesion was evaluated (surface/visual observation) based on the following criteria. The results are listed in Table 2. The thickness of the pressure sensitive adhesive layer refers to a value obtained by subtracting the thickness of the polyethylene terephthalate film (50 μm) from the thickness of the pressure sensitive adhesive sheet measured in accordance with JIS K7130.

o: No cohesive defect was observed.

x: Cohesive defect was observed.

In addition, for the cross section (length: 5 mm) of the obtained pressure sensitive adhesive layer, the presence or absence of cohesion having a size larger than the film thickness was observed with an optical microscope (magnification of 100×), and the cohesion was evaluated (cross section/microscope) based on the following criteria. The results are listed in Table 2.

o: No cohesion larger than the film thickness was observed.

x: Cohesion larger than the film thickness was observed.

TABLE 1

| | Composition of pressure sensitive adhesive composition | | | | | | | | | | | | | Particle size distribution |
|---|---|---|---|---|---|---|---|---|---|---|---|---|---|---|
| | | | | | | | | | | | Crosslinker | Inorganic | | Content rate of inorganic |
| | (Meth)acrylic ester polymer (A) | | | | | | | | | | (B) | filler (C) | | filler having particle |
| | | | a1-1 | a1-2 | a1-3 | a1-4 | a1-5 | a1-6 | a1-7 | | Mass | | Mass | diameter of 10 μm |
| | 2EHA | AA | C6 | | C10 | C12 | | C18 | | M w | parts | Type | parts | or more (vol %) |
| Example 1 | 80 | 5 | — | — | — | 15 | — | — | — | 750k | 3.75 | C 1 | 72 | 25.85 |
| Example 2 | 65 | 5 | — | — | — | 30 | — | — | — | 800k | 3.75 | C 1 | 72 | 25.92 |
| Example 3 | 75 | 10 | — | — | — | 15 | — | — | — | 880k | 3.75 | C 1 | 72 | 25.08 |
| Example 4 | 80 | 5 | — | — | — | 15 | — | — | — | 370k | 3.75 | C 1 | 72 | 26.35 |
| Example 5 | 80 | 5 | — | — | — | 15 | — | — | — | 1380k | 3.75 | C 1 | 72 | 26.98 |
| Example 6 | 80 | 5 | 15 | — | — | — | — | — | — | 1000k | 3.75 | C 1 | 72 | 26.91 |
| Example 7 | 80 | 5 | — | — | 15 | — | — | — | — | 720k | 3.75 | C 1 | 72 | 26.47 |
| Example 8 | 80 | 5 | — | — | — | — | — | 15 | — | 680k | 3.75 | C 1 | 72 | 26.08 |
| Example 9 | 83.5 | 1.5 | — | — | — | 15 | — | — | — | 800k | 3.75 | C 1 | 72 | 25.99 |
| Example 10 | 62 | 3 | 35 | — | — | — | — | — | — | 1200k | 3.75 | C 1 | 72 | 26.62 |
| Example 11 | 88 | 5 | — | — | 7 | — | — | — | — | 700k | 3.75 | C 1 | 72 | 26.85 |
| Example 12 | 80 | 5 | — | — | — | 15 | — | — | — | 750k | 3.75 | C 2 | 72 | 27.24 |
| Example 13 | 80 | 5 | — | — | — | 15 | — | — | — | 750k | 3.75 | C 3 | 72 | 26.12 |
| Example 14 | 80 | 5 | — | — | — | — | 15 | — | — | 780k | 3.75 | C 1 | 72 | 20.85 |
| Example 15 | 80 | 5 | — | 15 | — | — | — | — | — | 1200k | 3.75 | C 1 | 72 | 25.08 |
| Example 16 | 80 | 5 | — | — | — | — | — | — | 15 | 700k | 3.75 | C 1 | 72 | 24.27 |
| Comparative | 95 | 5 | — | — | — | — | — | — | — | 780k | 3.75 | C 1 | 72 | 35.86 |
| Example 1 | | | | | | | | | | | | | | |
| Comparative | 85 | — | — | — | — | 15 | — | — | — | 750k | 3.75 | C 1 | 72 | 55.46 |
| Example 2 | | | | | | | | | | | | | | |

TABLE 2

| | Dispersibility | | | | Evaluation of cohesion | |
|---|---|---|---|---|---|---|
| | Dispersion | | Rheology | | Coating surface/ | Cross section/ |
| | time (min.) | Evaluation | RI(η ₁₀/η ₁) | Evaluation | Visual observation | Microscope |
| Example 1 | 40 | ◯ | 0.975 | ◯ | ◯ | ◯ |
| Example 2 | 40 | ◯ | 0.965 | ◯ | ◯ | ◯ |
| Example 3 | 40 | ◯ | 0.980 | ◯ | ◯ | ◯ |
| Example 4 | 20 | ◯ | 0.939 | ◯ | ◯ | ◯ |
| Example 5 | 20 | ◯ | 0.892 | ◯ | ◯ | ◯ |
| Example 6 | 20 | ◯ | 0 901 | ◯ | ◯ | ◯ |
| Example 7 | 20 | ◯ | 0.934 | ◯ | ◯ | ◯ |
| Example 8 | 10 | ◯ | 0.953 | ◯ | ◯ | ◯ |
| Example 9 | 40 | ◯ | 0.955 | ◯ | ◯ | ◯ |
| Example 10 | 20 | ◯ | 0.928 | ◯ | ◯ | ◯ |
| Example 11 | 40 | ◯ | 0.915 | ◯ | ◯ | ◯ |
| Example 12 | 40 | ◯ | 0.871 | ◯ | ◯ | ◯ |
| Example 13 | 40 | ◯ | 0.942 | ◯ | ◯ | ◯ |
| Example 14 | 40 | ◯ | 0.951 | ◯ | ◯ | ◯ |
| Example 15 | 40 | ◯ | 0.912 | ◯ | ◯ | ◯ |
| Example 16 | 40 | ◯ | 0.938 | ◯ | ◯ | ◯ |
| Comparative | 60 | X | 0.754 | X | X | X |
| Example 1 | | | | | | |
| Comparative | Indispersible | X | 0.418 | X | X | X |
| Example 2 | | | | | | |

As apparent from Table 2, in the pressure sensitive adhesive compositions of Examples, the inorganic filler (C) was uniformly dispersed in a short time. Moreover, in the pressure sensitive adhesive layers formed from the pressure sensitive adhesive compositions of Examples, no cohesion was observed on the coating surface or the cross section, and the inorganic filler (C) was uniformly dispersed.

### INDUSTRIAL APPLICABILITY

The pressure sensitive adhesive composition, the pressure sensitive adhesive, and the pressure sensitive adhesive sheet according to the present invention can be used for attaching desired members, for example, in various electronic parts.

### DESCRIPTION OF REFERENCE NUMERALS

1 Pressure sensitive adhesive sheet

11 Base material

12 Pressure sensitive adhesive layer

13 Release sheet

1. A pressure sensitive adhesive composition containing:
a (meth)acrylic ester polymer (A) including an alkyl (meth)acrylate monomer (a1) and a reactive functional group-containing monomer (b) as monomer units that constitute the polymer; and
an inorganic filler (C),
wherein a carbon number of an alkyl group in the alkyl (meth)acrylate monomer (a1) is 6 or more and the alkyl group is linear.

2. The pressure sensitive adhesive composition according to claim 1, wherein the (meth)acrylic ester polymer (A) includes, in addition to the alkyl (meth)acrylate monomer (a1), an alkyl (meth)acrylate monomer (a2) (except for those in which the carbon number of the alkyl group is 6 or more and the alkyl group is linear) as a monomer unit that constitutes the polymer.

3. The pressure sensitive adhesive composition according to claim 2, wherein the (meth)acrylic ester polymer (A) contains 30 mass % or more and 95 mass % or less of the alkyl (meth)acrylate monomer (a2) as the monomer unit that constitutes the polymer.

4. The pressure sensitive adhesive composition according to claim 1, wherein the (meth)acrylic ester polymer (A) contains 5 mass % or more and 50 mass % or less of the alkyl (meth)acrylate monomer (a1) as a monomer unit that constitutes the polymer.

5. The pressure sensitive adhesive composition according to claim 1, wherein the reactive functional group-containing monomer (b) is a carboxy group-containing monomer.

6. The pressure sensitive adhesive composition according to claim 1, wherein the inorganic filler (C) comprises barium sulfate.

7. The pressure sensitive adhesive composition according to claim 1, wherein an average particle diameter of primary particles of the inorganic filler (C) is 0.01 μm or more and 10 μm or less.

8. The pressure sensitive adhesive composition according to claim 1, wherein the pressure sensitive adhesive composition contains a crosslinker (B).

9. A pressure sensitive adhesive obtained by crosslinking the pressure sensitive adhesive composition according to claim 1.

10. A pressure sensitive adhesive sheet comprising at least a pressure sensitive adhesive layer,
wherein the pressure sensitive adhesive layer is formed from the pressure sensitive adhesive composition according to claim 1.

11. The pressure sensitive adhesive sheet according to claim 10, comprising:
a base material; and
the pressure sensitive adhesive layer provided on one surface side of the base material.

12. The pressure sensitive adhesive sheet according to claim 10, wherein the pressure sensitive adhesive layer has a thickness of 1 μm or more and 50 μm or less.
